(19) United States
(12) Patent Application Publication
(10) Pub. No.: US 2009/0064407 A1
(43) Pub. Date: Mar. 12, 2009

(54) Device for Facilitating Access to a Sanitary Fitting

(76) Inventor: Daniel Alberto Altaparro, Barcelona (ES)

Correspondence Address: HONIGMAN MILLER SCHWARTZ & COHN LLP, 38500 WOODWARD AVENUE, SUITE 100, BLOOMFIELD HILLS, MI, 48304-5048, US

(21) Appl. No.: 12/298,753

(22) PCT Filed: Feb. 14, 2007
(86) PCT No.: PCT/ES2007/000079

§ 371 Date: Oct. 27, 2008

(30) Foreign Application Priority Data
Apr. 28, 2006 (ES) ES U 200600985

(51) Int. Cl. A47K 3/12; A61G 5/00

(52) U.S. Cl. 4/560.1

(57) ABSTRACT

A device for facilitating access to a sanitary fitting is disclosed. The device includes a guide mechanism adapted for connection with the sanitary fitting and a chair having a seat, front legs and rear legs, wherein the chair includes means for coupling the seat to the guide mechanism and means for moving the rear legs from a seat support position to an inactive position.

### TECHNICAL FIELD

The invention relates to devices for facilitating access to a sanitary fitting, to a mechanical system that allows for placing a person requiring assistance in a bathtub, a toilet or any other sanitary fitting that may also be handled by a single assistant and to seats and supports for bathrooms for the disabled, as well as wheelchairs for toilets.

### BACKGROUND

Known mechanisms for assisting disabled persons in a bathroom are (i) wheelchairs having padded support and a seat allowing for its use with a toilet; (ii) bath boards that can be attached to bathtubs; (iii) bath benches that can be attached to bathtubs that may have the ability to rotate about a vertical axis; and (iv) systems for sliding, immersion and elevation inside bathtubs, such as the mechanisms disclosed in patents MXPA02010094, JP2005279284, GB2411830 or U.S. Pat. No. 6,941,592.

Many of these mechanisms, however, require the assistance of two people to transfer a disabled person from a chair (with or without wheels) to the bathtub (with seat or board) or as set forth in EP1523972 and JP2005204704 do not allow for the use of the wheelchair in multiple types of environments such as a water closet or a bidet.

### SUMMARY

The present invention and specification hereof discloses devices for facilitating access to sanitary fittings.

The present invention and specification hereof discloses devices for facilitating access to a sanitary fitting comprising a guide mechanism adapted for connection with the sanitary fitting; a chair having a seat, front legs and rear legs, wherein the chair includes means for coupling the seat to the guide mechanism and means for moving the rear legs from a seat support position to an inactive position.

According to an embodiment of the invention, the invention is directed to an access to a sanitary fitting comprising a guide mechanism adapted for connection with the sanitary fitting; a chair having a seat, front legs and rear legs, wherein the chair includes means for coupling the seat to the guide mechanism and means for moving the rear legs from a seat support position to an inactive position.

According to an embodiment of the invention, the invention is directed to a device for facilitating access to a sanitary fitting comprises a chair having a seat, front legs rotatably connected to a front portion of the seat, rear legs removably connected to a rear portion of the seat, and wheels extending from the rear portion of the seat, wherein a rotation of the front legs in a forward direction decreases the length of each of the rear legs such that a vertical height of a front portion of the seat from the ground is the same as the vertical height of a rear portion of the seat; and a platform defining guides on a top surface thereof that selectively interact with the wheels of the chair when the chair is connected thereto.

According to an embodiment of the invention, the invention is directed to a device for facilitating access to a sanitary fitting having a platform attached thereto, the platform having guides thereon, the device comprising a chair having a seat, front legs rotatably connected to a front portion of the seat, rear legs removably connected to a rear portion of the seat, and wheels extending from the rear portion of the seat, wherein a rotation of the front legs in a forward direction decreases the length of each of the rear legs such that a vertical height of a front portion of the seat from the ground is the same as the vertical height of a rear portion of the seat, and wherein the wheels are housed within an upper portion of the rear legs when the rear legs are connected to the seat and exposed when the rear legs are removed from the seat such that the wheels may engage the guides defined in the platform.

### BRIEF DESCRIPTION OF THE DRAWINGS

The disclosure will now be described, by way of example, with the reference to the accompanying drawings, in which:

FIG. 1 is a perspective view of one form of a structure in the shape of a chair according to an embodiment of the invention.

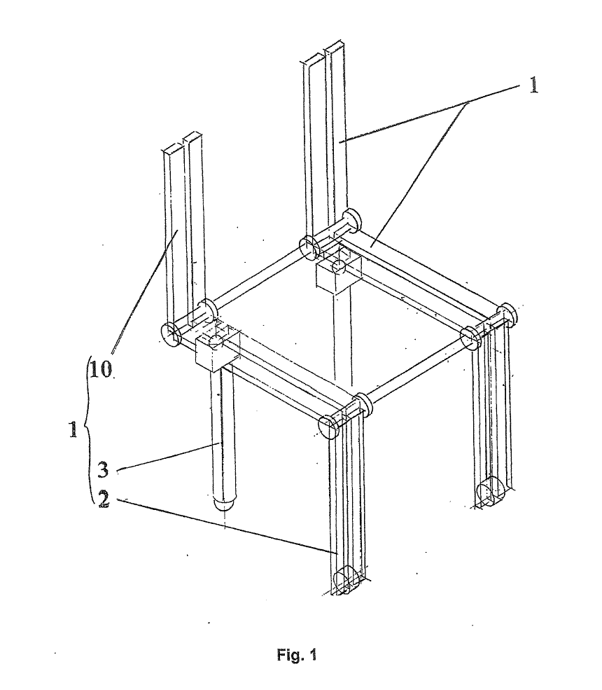

FIG. 2 is a side elevational view of one form of a structure in the shape of a chair and illustrates a platform that may be used in combination with the structure and anchored to a bathtub according to an embodiment of the invention.

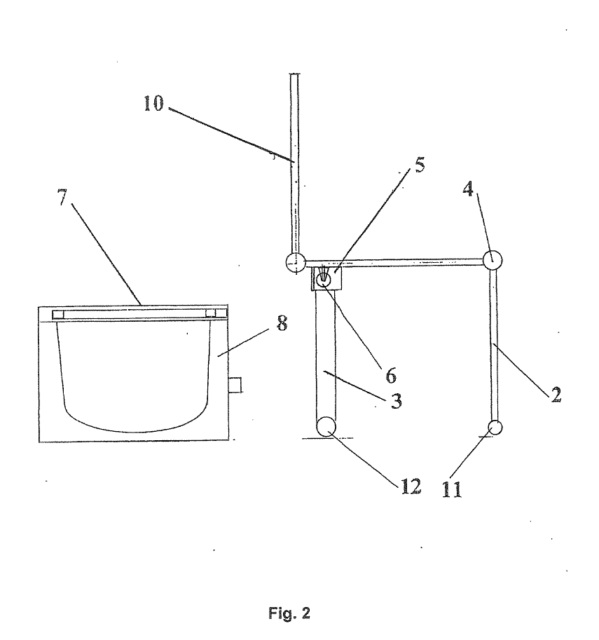

FIG. 3 is another side elevational view of one form of a structure and illustrates a platform anchored to the bathtub according to an embodiment of the invention.

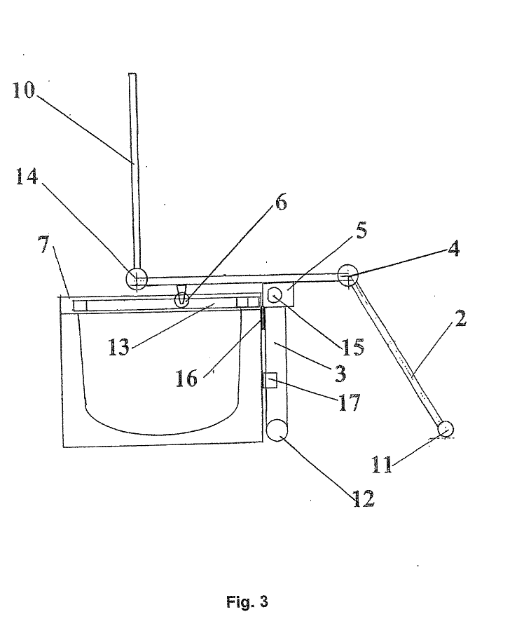

FIG. 4 is a planar view of one form of the structure illustrated in FIG. 3 that shows the path of rectilinear section guides and the path of circular section guides each of which are situated on the platform according to an embodiment of the invention.

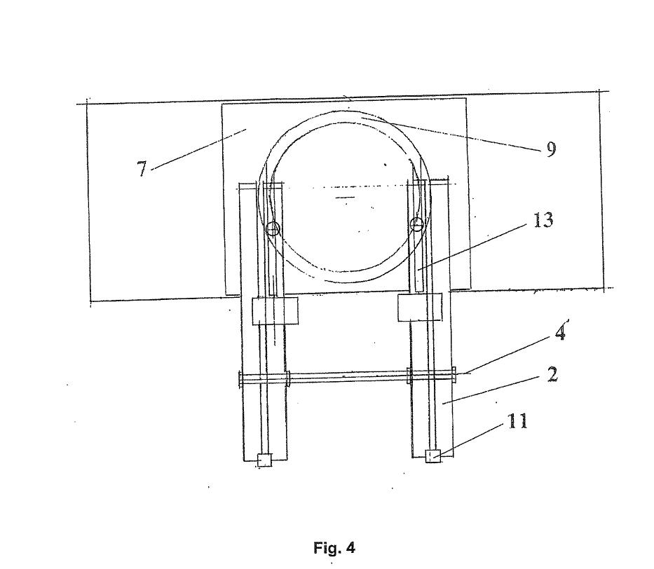

### DETAILED DESCRIPTION

The Figures illustrate an exemplary embodiment of a device for facilitating access to a sanitary fitting. It is to be generally understood that the nomenclature used herein is simply for convenience and the terms used to describe the invention should be given the broadest meaning by one of ordinary skill in the art.

In an embodiment, a device for access to a sanitary fitting includes a structure (1) having a metallic plate, hinged to a front axis (4) and a rear axis (14), in the shape of a wheelchair. In an embodiment, the structure (1) includes front legs (2) and rear legs (3) that are adjustable in height. In an embodiment, the structure (1) admits a cover that adapts to the structure and allows for bearing the weight of a sitter. In an embodiment, the structure (1) is supplemented with a platform (7), in wood or plastic material, which can be coupled to a bathtub (8). In an embodiment, the platform (7) includes rectilinear path guides (13) and circular path guides (9) that allow the structure to slide and rotate thereupon. In an embodiment, clamps (17), comprising rubber can be installed on the lateral access of the bathtub to facilitate a connection between the rear legs of the wheelchair with the bathtub when contact is made therebetween.

In an embodiment, the structure includes a mechanical transmission and a pneumatic mechanism (5) controllably connected to the mechanical transmission. In an embodiment, the mechanical transmission is adapted to rotate the front legs (2) of the chair forwards about the seat securing axis (4). In an embodiment, the pneumatic mechanism (5) is situated on the top of the rear legs (3) and proportionally reduces the length of the rear legs (3) while the front legs (2) are rotated forwards about the seat securing axis to maintain the horizonality of the seat and its situation at the desired height. In an embodiment, the front legs (2) rotate forwards as they maintain contact with the floor by sliding with the aid of cylindrical wheels (11).

In an embodiment, the rear legs (3) are secured to the chair by coupling the top of the rear legs (3) to spherical wheels (6), associated with the rear underside of the base of the chair. In an embodiment, this coupling is secured by a manually actuated mechanical clamp (16). In an embodiment, the rear legs (3) can slide along the floor by means of spherical wheels (12).

In an embodiment, the structure (1) is used in combination with the other structure in which the user of the structure (1) intends to transfer. For purposes of the following method, the disclosure will refer to a bathtub but it should be appreciated that other structures are contemplated and the invention hereof should not be limited to the exemplary bathtub. In an embodiment, once the chair has been moved up to an appropriate position alongside a bathtub, with the platform (7) installed the user can adjust the seat to a suitable seat height to allow such user to transfer the seat to the platform. In an embodiment, the rear legs (3) of the chair will firstly be coupled to the clamps (17) and then will be able to be decoupled from the chair and the spherical wheels by opening the clamps (16) to thereby allowing the wheels (6) to engage the platform (7).

In an embodiment, and as set forth in the examples heretofore provided, the support of the structure is achieved by using the spherical wheels (6) and their engagement with the rectilinear guides (13) that are situated on the platform (7).

In an embodiment, the uncoupling of the wheels (6) from their accommodation (15) causes, inside the height adjustment mechanism (5), the front legs to release from their position.

In an embodiment, the rectilinear guides (13) continue until reaching the circular path guides (9), to allow, after lifting the front legs (2) into a horizontal position, the chair to be rotated in one of both directions until being placed in the same direction as the bathtub.

In an embodiment, both path guides are lined in steel foil that is resistant to the force and to the rolling effect.

In an embodiment, the back (10) of the chair may be lowered into a horizontal position so that, if necessary, it can support a person lying down completely in the bathtub.

In an embodiment, at the rotation axis (14) of the back and at the rotation axis (4) of the front legs, there is a securing mechanism incorporated at several inclinations, by means of locating pips of variable anchorage.

The structure (1) in the shape of a chair can also be used independently to access other sanitary fittings such as the WC or bidet, allowing, in these cases, for obtaining the height of the seat adapted for its right utilization.

Thanks to the seat coupling to the guide mechanism, with the rear legs being in an inactive position, it is possible for a single assistant to transfer the handicapped person without having to get them up, until placing them on the upper area of the sanitary fitting.

Advantageously, the means for coupling to the guide mechanism comprise an automatic mechanism for shortening the rear legs and wheels associated to the seat. In this way, the seat stays at the same level as the guide mechanism and can be moved, supported on rotary elements.

According to a preferred embodiment, the automatic mechanism for shortening the rear legs is activated as a consequence of the manual forward rotation of the front legs. This process facilitates the assistant obtaining the seat height.

According to an embodiment the wheels associated to the seat are spherical. Since they have this shape, the wheels can be easily coupled to the guide mechanism.

According to an embodiment, the front and rear legs are provided with sliding means. This fact allows for the chair to be approximated to the sanitary fitting until the access position, and furthermore, allows for the front legs to be rotated forwards by the assistant.

According to an embodiment, the means for moving the rear legs from a support position to an inactive position operate so as to accomplish the extraction of the spherical wheels from their accommodation on the top of the same rear legs. Thanks to this process, the rear legs are liberated from the chair and simultaneously the spherical wheels associated to the chair can access the guide mechanism.

According to a preferred embodiment, the chair back is lowerable until a horizontal position, being able to be adjusted at several intermediate positions. This capacity allows for choosing the most suitable position in each case.

Advantageously the whole chair may foldable allowing for putting it away using the minimum space.

1-9. (canceled)

10. A device for facilitating access to a sanitary fitting comprising:
a guide mechanism adapted for connection with the sanitary fitting; and
a chair having a seat, front legs and rear legs, wherein the chair includes means for coupling the seat to the guide mechanism and means for moving the rear legs from a seat support position to an inactive position.

11. A device for facilitating access to a sanitary fitting according to claim 10, wherein the lengths of the rear legs are selectively adjustable, and wherein the means for coupling the seat to the guide mechanism includes wheels removably connecting the rear legs to the seat and an automatic mechanism for adjusting the lengths of the rear legs.

12. A device for facilitating access to a sanitary fitting according to claim 11, wherein the front legs are rotatably connected to the seat and wherein the lengths of the rear legs are selectively and automatically adjusted based upon a rotation of the front legs.

13. A device for facilitating access to a sanitary fitting according to claim 12, wherein the wheels are sphere-shaped.

14. A device for facilitating access to a sanitary fitting according to claim 12, wherein each of the front legs and the rear legs include a first end proximate the seat and a second end positioned distal from the seat, wherein the second ends are provided with means for moving the chair about a floor.

15. A device for facilitating access to a sanitary fitting according to claim 14, wherein the means for moving the rear legs from a support position to an inactive position operate so to achieve the extraction of the wheels of spherical shape from their accommodation at the top of the same rear legs.

16. A device for facilitating access to a sanitary fitting according to claim 10, wherein the guide mechanism includes a platform having one or both of rectilinear path guides and circular path guide and wherein the platform is anchored to the sanitary fitting.

17. A device for facilitating access to a sanitary fitting according to claim 10, wherein the chair further comprises a back movably connected to the chair between a first substantially vertical position and a second substantially horizontal position, and wherein the back is securable at one or more intermediate positions therebetween.

18. A device for facilitating access to a sanitary fitting according to claim 10, wherein the entire chair is foldable.

19. A device for facilitating access to a sanitary fitting comprising:
a chair having a seat, front legs rotatably connected to a front portion of the seat, rear legs removably connected to a rear portion of the seat, and wheels extending from the rear portion of the seat, wherein a rotation of the front legs in a forward direction decreases the length of each of the rear legs such that a vertical height of a front portion of the seat from the ground is the same as the vertical height of a rear portion of the seat; and
a platform defining guides on a top surface thereof that selectively interact with the wheels of the chair when the chair is connected thereto.

20. A device for facilitating access to a sanitary fitting according to claim 19, wherein the wheels are housed within the rear legs when the rear legs are connected to the seat and exposed when the rear legs are removed from the seat such that the wheels may engage the guides defined in the platform.

21. A device for facilitating access to a sanitary fitting according to claim 19, wherein the length of each rear leg is automatically adjusted based upon a position of the front legs.

22. A device for facilitation access to a sanitary fitting according to claim 21, wherein the rotation of the front legs is manually controlled.

23. A device for facilitating access to a sanitary fitting according to claim 19, wherein the chair includes means for sensing the position of the front legs and adjusting the length of each rear leg based upon the position of the front legs.

24. A device for facilitating access to a sanitary fitting according to claim 23, wherein the sensing and adjusting means including a pneumatic device that adjusts the lengths of the rear legs.

25. A device for facilitating access to a sanitary fitting according to claim 19, wherein the guides include one or both of rectilinear path guides and circular path guides.

26. A device for facilitating access to a sanitary fitting according to claim 20, wherein the platform is anchored to the sanitary fitting.

27. A device for facilitating access to a sanitary fitting according to claim 19, wherein the chair further comprises a back movably connected to the chair between a first substantially vertical position and a second substantially horizontal position, and wherein the back is securable at one or more intermediate positions therebetween.

28. A device for facilitating access to a sanitary fitting having a platform attached thereto, the platform having guides thereon, the device comprising:
a chair having a seat, front legs rotatably connected to a front portion of the seat, rear legs removably connected to a rear portion of the seat, and wheels extending from the rear portion of the seat, wherein a rotation of the front legs in a forward direction decreases the length of each of the rear legs such that a vertical height of a front portion of the seat from the ground is the same as the vertical height of a rear portion of the seat, and wherein the wheels are housed within an upper portion of the rear legs when the rear legs are connected to the seat and exposed when the rear legs are removed from the seat such that the wheels may engage the guides defined in the platform.

29. A device for facilitating access to a sanitary fitting according to claim 28, wherein the chair further comprises a back movably connected to the chair between a first substantially vertical position and a second substantially horizontal position, and wherein the back is securable at one or more intermediate positions therebetween.
